(19) United States
(12) Patent Application Publication
(10) Pub. No.: US 2007/0236343 A1
(43) Pub. Date: Oct. 11, 2007

(54) Surveillance network for unattended ground sensors

(76) Inventors: Albert Michael Becksted, Brentwood Bay (CA); Allan Stokes, Victoria (CA)

Correspondence Address: Fasken Martineau DuMoulin LLP, 2100 - 1075 West Georgia Street, Vancouver, BC, V6B 3G2, CA

(21) Appl. No.: 11/233,099

(22) Filed: Sep. 23, 2005

Related U.S. Application Data
(60) Provisional application No. 60/612,154, filed on Sep. 23, 2004.

(51) Int. Cl. G08B 19/00; G08B 1/08

(52) U.S. Cl. 340/521; 340/539.22

(57) ABSTRACT

A method for responding to a sensor event is provided, comprising the steps of: (a) recognizing and analyzing a sensor event, and declaring an alarm condition; (b) taking a picture, storing the picture, and transmitting the picture to a central server; (c) notifying subscribers with a message that can contain visual confirmation and other data describing the alarm event; and (d) interrogating a module, downloading event data and images.

This application claims benefit of U.S. Provisional Patent Application No. 60/612,154 filed Sep. 23, 2004, which is hereby incorporated by reference.

### FIELD OF THE INVENTION

The present invention relates to surveillance networks for unattended ground sensors and more particularly to methods and systems for remote surveillance, transmission, recording and analysis of images and sensor data.

### BACKGROUND OF THE INVENTION

Many different forms of such surveillance systems are known. The sensors in such systems may be connected through a wireless link to a central data collector. However, these systems do not differentiate the sensor data collected, resulting in important data being buried in huge amounts of irrelevant data and large numbers of false positives. Such systems cause delay of the information flow and do not provide visual confirmation of the remote site that is to be monitored.

Other common problems with current surveillance systems include the isolation of each sensor array (i.e. they are not networked with the other arrays). This results in limited situational awareness for the responding personnel. Also the resulting data is typically raw and unprocessed, resulting in large amounts of unnecessary data and false positives. Furthermore there is no visual confirmation, further limiting situational awareness. There are also typically long delays in information flow to responding personnel resulting in an inability to effectively respond to the situation.

U.S. Pat. No. 4,550,311 discloses a security installation at one site having remote sensors, which detect intrusion, fire, etc. and transmit corresponding signals by radio to a master station.

U.S. Pat. No. 6,317,029 discloses an in situ remote sensing system including a plurality of sensors that are distributed about an area of interest, and a satellite communications system that receives communications signals from these sensors.

U.S. Pat. No. 6,171,264 discloses, in a medical measurement system, measurements taken at a distance from a hospital. The patient is connected to a measuring system comprising measuring sensors and a unit for collecting data comprising a transmitter.

U.S. Pat. No. 6,160,993 discloses a method and apparatus for providing command and control of remote systems using low earth orbit satellite communications.

U.S. Pat. No. 6,466,258 discloses a customer premise or site fitted with cameras and other sensors. The sensors are interconnected with a central station, which monitors conditions.

U.S. Pat. No. 6,480,510 discloses a serial intelligent cell and a connection topology for local area networks using electrically conducting media.

U.S. Pat. No. 6,292,698 discloses a system for communicating with a medical device implanted in an ambulatory patient and for locating the patient in order to selectively monitor device function, alter device operating parameters and modes and provide emergency assistance to and communications with a patient.

U.S. Pat. No. 6,148,196 discloses a system for transmitting instructions from a master control facility to a number of remotely located player unit. The remotely located player units communicate through a mobile cell site.

U.S. Pat. No. 6,141,531 discloses a wireless communication system using radio frequencies for transmitting and receiving voice and data signal with an internal network with multiple internal communication path, and an external communication path for linking the internal network to an external communications network and is suited to operate in remote locations that are isolated.

U.S. Pat. No. 5,449,307 discloses an apparatus and method for establishing and maintaining control over an area of the sea from a remote location, consisting of a remote control point, a number of submersible satellite stations and means for communicating by radio or conductive cable between the control point and each station.

U.S. Pat. No. 5,816,874 discloses a portable, anchored sensor module for collecting fresh water environmental data over a range of depths, is supported relative to a buoy having a power supply and control circuitry.

U.S. Pat. No. 5,557,584 discloses a system of sonar platforms designed for use in moderate depth water is disclosed, with each platform having a plurality of transducer modules mounted thereon.

US Patent application publication number 20020057340 discloses integrated imaging and GPS network monitoring remote object movement. Cameras detect objects and generate image signal. Internet provides selectable connection between system controller and various cameras according to object positions.

US Patent application publication number 20020174367 discloses a system and method for remotely monitoring sites to provide real time information which can readily permit distinguishing false alarms, and which can identify and track the precise location of an alarm implemented through the use of multistate indicators which permits information to be transmitted using standard network protocols from a remote site to a monitoring station in real-time.

US Patent application publication number 20020109863 discloses an image capture, conversion, compression, storage and transmission system provides a data signal representing the image in a format and protocol capable of being transmitted over any of a plurality of readily available transmission systems and received by readily available, standard equipment receiving stations.

US Patent application publication number 20020153419 discloses a weather resistant modular sensor and computing platform reduces costs and enhances versatility of sensor systems. A cylindrical shaped modular system provides an architecture for up-grading sensors, batteries, special modules, communications, and control.

### BRIEF SUMMARY OF THE INVENTION

According to the present invention, a plurality of sensors are situated at different positions in an area to be monitored (such as a building, a pipeline, a border, a road, etc.) and are arranged to sense the presence of an intruder or the movement of an object. Each sensor is arranged to transmit signals representative of what it is sensing to a module which is in or near the area being monitored and which then responds by taking appropriate action such as replicating data (for example images, notifications, or sensor data) and transmitting to a distant location (for example, by means of a cellular or satellite network)

By using distributed computing, cameras, and communication channels with global coverage, sensor events can be discriminated, images can be analyzed, and then the important data can be transmitted from the module to a central station, providing the responding person or team with full situational awareness.

The system according to the invention may include a module, one or more sensors with a camera, a server, and a user interface device. The system is connected via, a distributed computing network. The module allows the system to discriminate sensor events by processing the raw data and making sense of it. Therefore, the data is transmitted selectively, making best use of limited communication channels. A communication channel with global coverage allows total data integration for high level responding personnel, and digital day/night cameras allows for constant visual confirmation.

Advantages of the present invention include the conversion of raw data into meaningful information to give full situational awareness to responding personnel. Mission critical data is accessible concurrently to multiple stations in the responder chain. Visual confirmation of the situation is provided to reduce false positives. A global footprint allows for deployment anywhere in the world. Near real-time alerts allow quick response or prevention.

### BRIEF DESCRIPTION OF THE DRAWINGS

FIG. 1 is an overall representation of an embodiment of a system according to the invention;

FIG. 2 is a block diagram of an embodiment of a module and sensor at a remote site;

FIG. 3 is a block diagram of the organization of an embodiment of a system according to the invention;

FIG. 4 is a view of an embodiment of a communication system according to the invention;

FIG. 5 is a view of the communications paths within a global system according to the invention;

FIG. 6 is a view of a map illustrating the Use Case Road;

FIG. 7 is a view of a map illustrating the Use Case Pipeline;

FIG. 8 is a view of an embodiment of a module according to the invention;

FIG. 9 is a block diagram of the components thereof;

FIG. 10 is an alternative view of the connections in an embodiment of the invention;

FIG. 11 is a block diagram of the software in a module according to an embodiment of the invention;

FIG. 12 is a view of a sample daytime photo;

FIG. 13 is a view of a sample nighttime image captured with an intensified camera;

FIG. 14 is a view of an embodiment of a graphical user interface according to the invention;

FIG. 15 is a view of an image file according to the invention;

FIG. 16 is an alternate view thereof;

FIG. 17 is an alternate view thereof;

FIG. 18 is an alternate view thereof;

FIG. 19 is an alternate view thereof;

FIG. 20 is an alternate view thereof showing a region of interest in higher quality; and

FIG. 21 is a view showing images that have been digitally zoomed.

### DETAILED DESCRIPTION OF THE INVENTION

Note in this document the terms “module” and “C3Module” are used interchangeably.

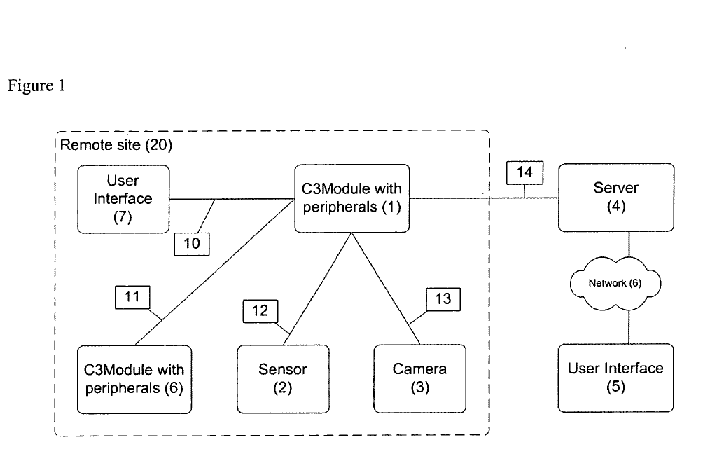

As seen in FIG. 1, a system according to the invention is used to monitor a remote site 20, for example a pipeline, a power plant, a border or other location. At remote site 20 is deployed at least one module 1, at least one camera 3, at least one sensor 2, and optionally, other devices. Server 4 is located at a central station anywhere. Responding personnel can access the stored data at module 1 or be notified of an event directly from module 1 through connection 10 to user interface 7 or indirectly from module 1 to server 4 and network 6 to user interface 5 through connection 14.

Sensors 2 are preferably covertly deployed in a manner to protect an asset or monitor a perimeter or other object at remote site 20. If an intruder enters remote site 20, sensor 2 sends a signal to module 1 through a communication channel 12. Communication channel 12 is preferably wireless, such as a digital RF link, although other communication links as known in the art can also be used. When the module 1 receives the signal from the sensor, it logs the event and processes it through the discrimination patterns stored in module 1. Processing of the sensor event by module 1 results in a multitude of actions to be performed. For example, module 1 may instruct camera 3 to take one or more images. After these images are taken, they are transmitted from camera 3 to module 1 through connection 13 (which could be an Ethernet Wireless LAN, or other), where they are stored.

Another possible action after processing the event could be a data movement. Data to be moved can be system data (e.g. temperature, power level, operational and other parameters), event data (e.g. time, location, type, or others), and image data (e.g. highly compressed or detailed). In order to move data, module 1 contacts server 4 through connection 14, which may be a satellite connection, a cellular connection, a RF connection, or other as known in the art. Module 1 then uploads the data to server 4. The data might be moved also to another module 6 through connection 11 (which may be a digital RF, satellite connection, or other as known in the art).

Responding personnel can download data to module 1 (such as optimized discrimination patterns or software updates). To do that, a user connects to module 1 from user interface 7 through connection 10 (which may be an Ethernet connection, a Digital RF connection, or other as known in the art). The user then downloads data to module 1 where it is stored. The user can also download data from user interface 5, which may be a web browser on a PC, a Laptop, or a PDA, through network 6 (which may be a public network like the Internet, or a private network) to server 4 and from there through connection 14 to module 1.

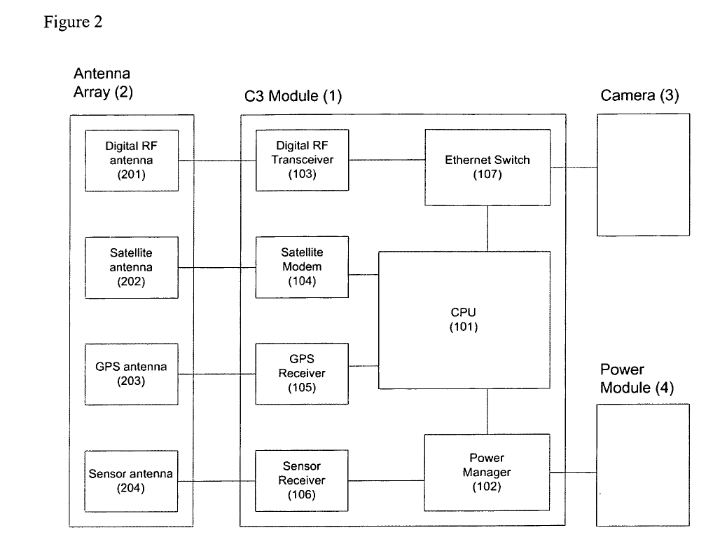

FIG. 2 displays a representation of an equipment assemblage and interconnection at a remote site. The core component is module 1. Attached to module 1 are antennas for wireless communication, which can be integrated in antenna array 2 or installed externally. Also connected to module 1 are one or more cameras 3 and one or more power modules 4.

Module 1 preferably contains the following components:

1. Digital RF Transceiver 103, which may be an 802.11b device or other, as known in the art. Transceiver 103 allows local communication with the user interface, other modules or other devices.

2. Satellite Modem 104, which may be an Iridium satellite modem or other as known in the art. Modem 104 allows global communication with servers, other modules or other devices.

3. GPS receiver 105 allows reception of GPS satellite signals to determine location of module 1 and update the time base precisely.

4. Sensor receiver 106 may be a Qual-Tron EMIDS receiver or other as known in the art. Receiver 106 allows reception of sensor alerts, triggered when an intruder enters remote site, to be monitored.

5. Power manager 102 turns components on and off as necessary to maximize the battery life.

6. Ethernet switch 107 allows connection of one or more wired devices. These devices can be cameras 3 or other devices.

7. Power module 4 provides energy to the module 1 and its peripheral devices. Other devices can provide energy as well (e.g. solar cells).

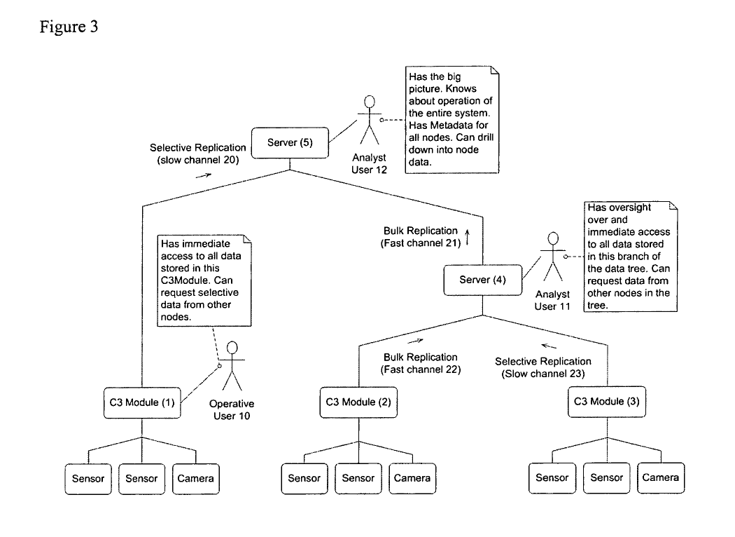

The data in the system is organized in a tree structure, as seen in FIG. 3, and replicated towards the top node server 305. Each module decides what data to replicate partially based on the bandwidth of the communication channel. Module 2, for example, has fast channel 322 and therefore transmits a lot of data (e.g. Images, operational data, sensor and other data) to server 304. Server 304 in turn, also has a fast channel and transmits all data it receives from modules 302 and 303 to server 305 through the fast channel 321. Module 303 has a slow channel and therefore replicates and transmits only a small portion of the logged data through slow channel 323 to server 304. The discrimination patterns stored in module 303 determine what data gets replicated depending on its sensor alert patterns. Module 301 also replicates only a small portion of the logged data through slow channel 320 to server 305. Operative user 310 has access to all locally logged data through a faster local communication path and can make decisions based on that data. Analyst user 312 sees only that portion of data logged at module 301 that was replicated and transmitted to server 305. Module 301 has discrimination patterns programmed that decide what data gets replicated and transmitted to server 305 to be available to high level decision makers. This architecture allows concurrent access to mission critical data at many levels of the system.

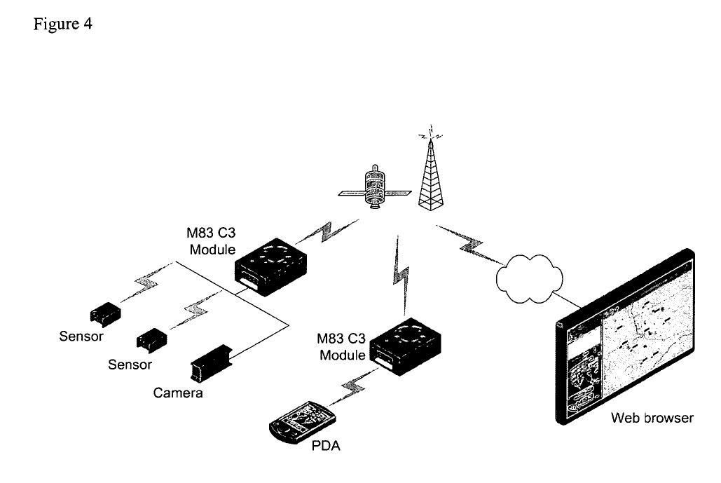

The system according to the invention, an alternative embodiment of which is seen FIG. 4, provides a complete solution for global unattended ground sensor information gathering and sensor-triggered imaging for security surveillance. It is a field-ready intelligent computing and communications system. It is able to synthesize global knowledge and intelligence from raw data, which reduces false positives. It preferably employs sensor-triggered high-resolution digital day/night imaging, two-way communications to sensor arrays deployed anywhere in the world and is managed using a secure map-based graphical user interface from a browser.

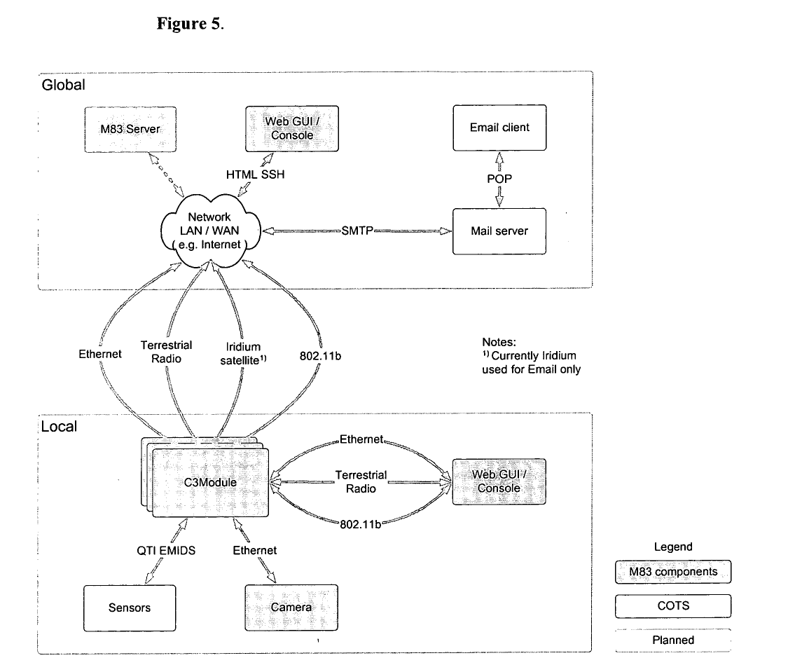

FIGS. 5 shows an embodiment of the communication paths used by a system according to the invention. Multiple parallel paths are provided to ensure reliable global communications.

The system provides for global operation allowing worldwide access to sensor events and images and such access is preferably in real or near real-time. As well there are multiple communication path options (preferably Iridium, Globalstar, other satellites, cellular, and/or terrestrial-900 MHz ).

The system provides for visual confirmation of events. High-resolution digital images may be sent to the user. Night vision, Generation III Intensified cameras are preferably employed. Image capture is triggered automatically by sensor events and can be activated on demand. These images provide for increased situational awareness

The system also allows for processing of the information and data gathered. The system synthesizes global knowledge and intelligence from raw data using sensor discrimination/pattern recognition. Such processing significantly reduces false positives from sensor alerts and allows for data storing and advanced data mining.

Evidential characteristics of an event are recorded in a module, such as time stamp and location information. The information can be sent to multiple notification recipients, such as decision makers, commanders, and local operators, thus putting the information into the hands of multiple layers of command simultaneously allowing for defensive action to be taken quickly.

The system is preferably easy to operate and is capable of simple and rapid deployment with a low manpower requirement and cost. The system is preferably designed to be inter-operable with existing or future systems by integrating multiple sensor types, including radiological, and chemical or biological, or from an unmaned aerial vehicle. Standard network protocols are preferably used and modules should have multiple input/output ports.

The modules preferably are made using commercial off the shelf hardware, which besides being available and economical, are also adaptable and use standard interfaces.

The software used in the system is preferable based on open source and is secure, reliable, and adaptable. The software is preferably scalable, customizable, and inter-operable and includes sensor discrimination and pattern-recognition algorithms. Such algorithms should include multiple trigger scenarios.

The system could be used in a variety of situations and environments, including military, homeland security, and law enforcement for uses such as perimeter security, force protection, intelligence operations, and border patrol. The system can also be used to protect assets such as power plants, hydro dams, transmission lines, pipelines, oil fields, refineries, ports, airports, roads, and water supplies as well as protect product movement to the commercial security industry.

Use Case: Road

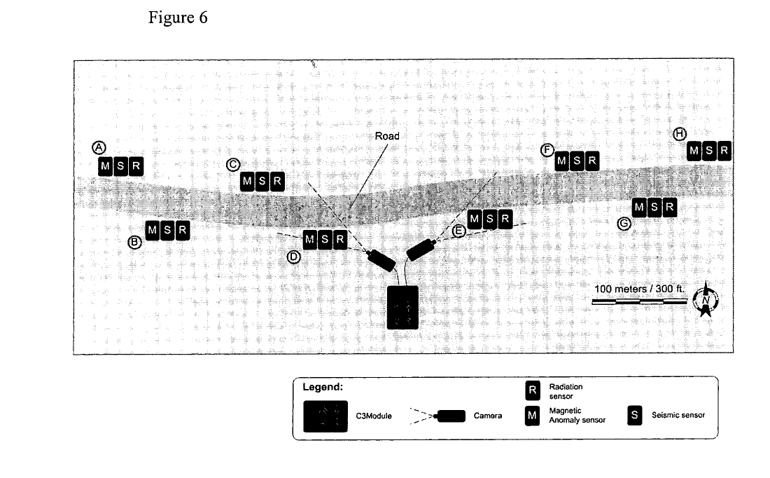

FIG. 6 shows an example of a use of a system according to the invention, entitled “Use Case: Road”. In this example, the task of the system is to monitor traffic on a remote road. The system is used to monitor pedestrian as well as vehicle traffic on such road. Seismic (S), magnetic anomaly (M), and radiological (R) sensors are placed along the road in both directions from the module.

Connected to the module are two cameras, facing in opposite directions along the road. The module can be easily programmed for specific scenarios, for example reporting vehicle traffic going East to West only; or reporting pedestrian traffic going West to East only; or reporting vehicles slower than 60 km/h (e.g. a potential armored track vehicle).

Scenario 1: Walk Through

With reference to FIG. 6, a person or persons walk through the area from West to East. The sensors trigger in the following order:

1. A: Seismic at 16:23 UTC

2. B: Seismic at 16:24 UTC

3. C: Seismic at 16:24 UTC

4. D: Seismic at 16:25 UTC

5. E: Seismic at 16:26 UTC

6. F: Seismic at 16:27 UTC

7. G: Seismic at 16:27 UTC

8. H:Seismic at 16:28 UTC

Since there are no Magnetic Anomaly sensor triggers, the module assumes that the intruder walking through carries no metal weapons or tools, which gives this intruder a low threat level. The trigger times suggest that the intruder didn't loiter at any time along the path and moved steadily through the area. This is determined to be a harmless walk through and results in no raised alert level or notification.

However the module captures an image at Sensor trigger D and stores the image for future use or post analysis of traffic on the road. This can be useful to reconstruct what had happened at a certain time of interest.

Scenario 2: Drive Through

Again with reference to FIG. 6, a vehicle drives through the area from East to West. The sensors trigger in the following order:

1 H: Seismic and Magnetic Anomaly at 16:23 UTC

2 G: Seismic and Magnetic Anomaly at 16:23 UTC

3 F: Seismic and Magnetic Anomaly at 16:23 UTC

4 E: Seismic and Magnetic Anomaly at 16:24 UTC

5 D: Seismic and Magnetic Anomaly at 16:24 UTC

6 C: Seismic and Magnetic Anomaly at 16:24 UTC

7 B: Seismic and Magnetic Anomaly at 16:24 UTC

8 A:Seismic and Magnetic Anomaly at 16:24 UTC

Therefore, there are Seismic, as well as Magnetic Anomaly, triggers in very short time. This is likely a vehicle driving through on the road. The module captures an image at Sensor trigger E, stores it locally, and transmits a report through the network to a user.

Magnetic anomaly sensors with variable gains may be able to classify large and small vehicles. Seismic sensors can be used to determine velocity of traffic. In any case the module will monitor all sensors and may classify targets (as transmitted to the server) as (for example):

Message: Large truck, driving east at 40 km/hr.

Scenario 3: Radiological Event

Radiological sensors in a linear array may detect radioactive or “hot” vehicles passing by. Such a hot vehicle will almost always trigger an alarm and notification.

Use Case: Pipeline

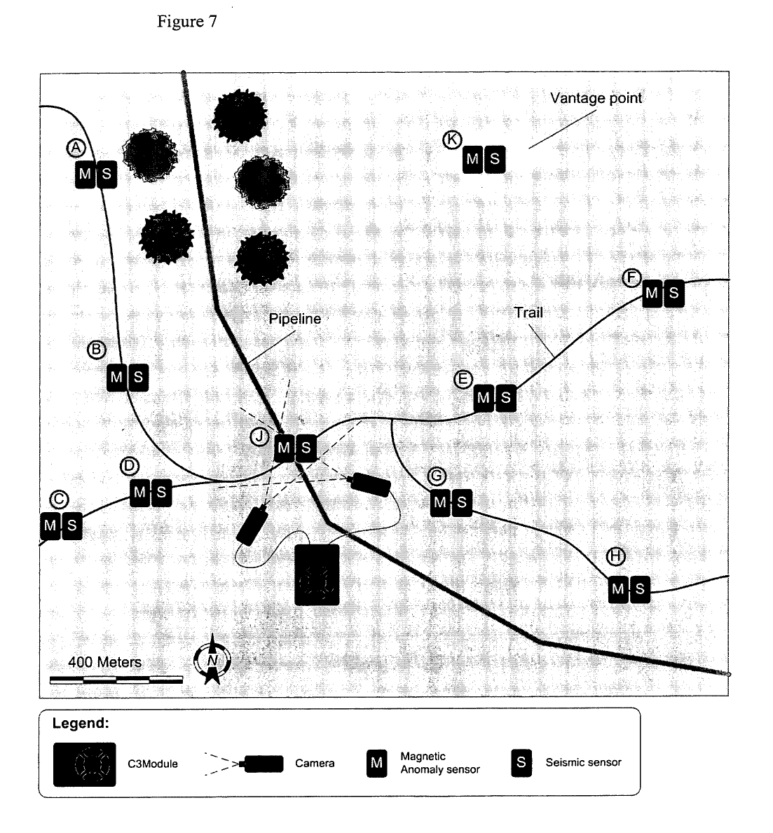

FIG. 7 shows an example of a use of a system according to the invention, entitled “Use Case: Pipeline”. In this example, the system's task is to monitor a pipeline in a remote and inaccessible area where no vehicle traffic is possible. There is a trail system around the pipeline, which may be used by intruders to access the pipeline and sabotage it. The objective of the system is to provide alerts and notifications with visual confirmation to a central Command and Control center. Personnel at that center can respond to disturbances and prevent damage being done to the pipeline. FIG. 7 displays the module, sensors (magnetic and seismic) and cameras used.

Scenario 1: Walk Through

A person or persons walk through the area from the Northwest corner down to the Southeast corner of the map. The sensors trigger in the following order:

1 A: Seismic at 10:03 UTC

2 B: Seismic at 10:08 UTC

3 J: Seismic at 10:12 UTC

4 G: Seismic at 10:16 UTC

5 H: Seismic at 10:21 UTC

Since there are no Magnetic Anomaly sensor triggers, the module determines that the intruder walking through carries no metal weapons or tools, which gives this intruder a low threat level. The trigger times suggest that the intruder didn't loiter at any time along the trail. This is considered a harmless walk through and does not result in a raised alert level or notification.

However the module will capture an image at Sensor trigger J and store the image for post analysis of activity along the pipeline. This can be useful to reconstruct what had happened at certain times of interest at the pipeline.

Scenario 2: Walk In and Loitering at Pipeline

A person or an animal walks in towards the pipeline from the Northwest corner down to the pipeline and then back out to the Northwest corner of the map. The sensors trigger in the following order:

1 A: Seismic at 10:03 UTC

2 B: Seismic at 10:08 UTC

3 J: Seismic at 10:12 UTC, disturbance at J continues until 10:41 UTC

4 G: Seismic at 10:45 UTC

5 H: Seismic at 10:50 UTC

Since there are no Magnetic Anomaly sensor triggers, we can assume that the intruder walking in carries no metal objects, which gives this intruder a low initial threat level. The trigger times suggest that the intruder walked directly to the pipeline and spent about half an hour at the pipeline. This activity elevates the event to a threat or alarm.

The module will capture an image at Sensor trigger J, store it locally, and move the report through the network to the end user.

The Module

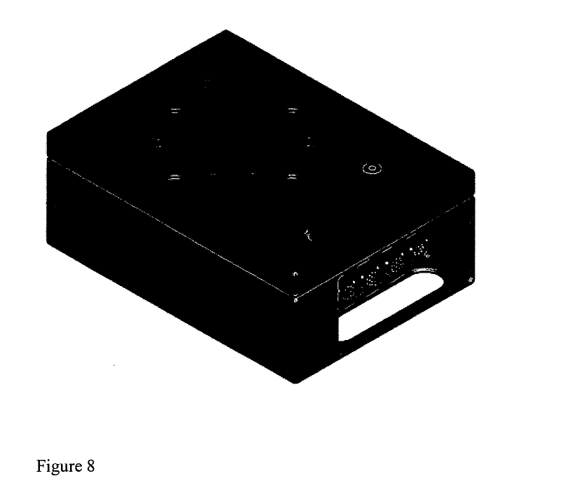

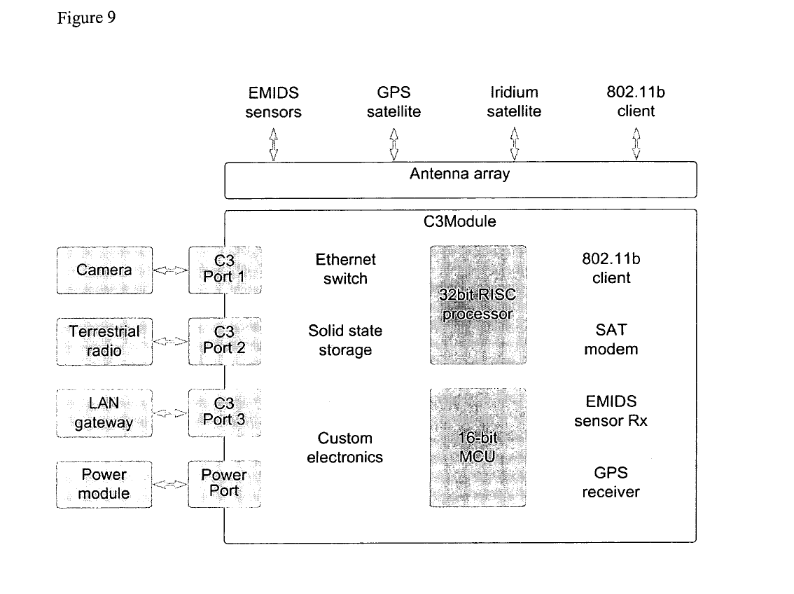

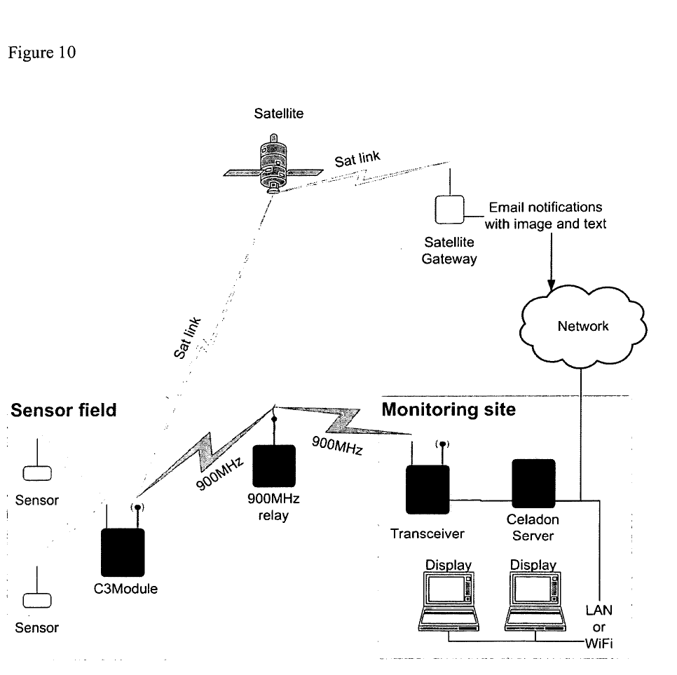

As seen in FIG. 8, the module used in the system according to the invention is the field computing unit of the system. As seen in FIG. 9, the module is a rugged, field-ready computer that networks with the sensors. When the module is deployed, sensor arrays have a master controller to analyze inputs from multiple data types and make decisions based on sophisticated logic. Peripheral cameras and sensing devices also collect images and data. Integrated communications components, as seen in FIG. 10, securely transmit images and interpreted data of significant events to a central command location anywhere on the planet through satellite. Each module has two-way communication ability to remotely upgrade algorithms based on changing scenarios.

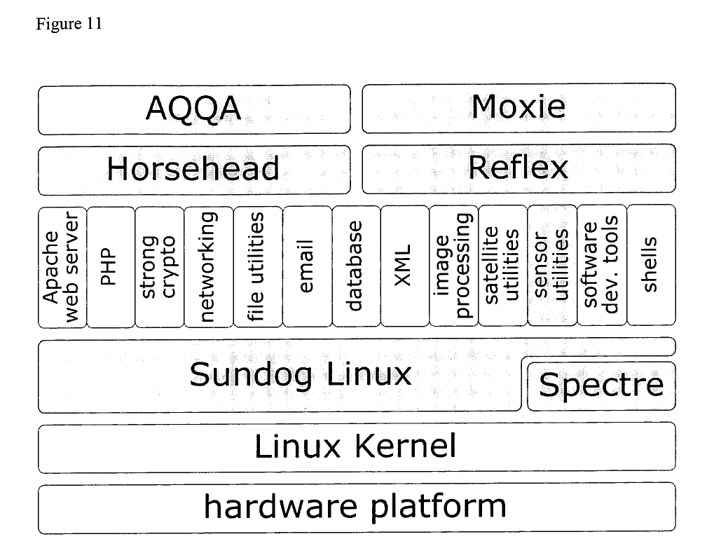

The module employs software to operate its components and evaluate events, as seen in FIG. 11.

The operational specifications of the module preferably include the following:
Power consumption from 1 mW (in deep sleep mode) to 30 W (when the system is fully active with night time illumination for cameras);
Typical battery life of 2.5 months depending on battery configuration and usage;
Additional batteries and solar panels to extend operational life;
a 900 MHz terrestrial relay with a range of approximately 20 km, depending on terrain;
Iridium link speed of 2.4 Kbps; and
GlobalStar link speed of 7 kbps.

The system according to the invention allows for information synthesis in that actionable information is created from raw data, reducing false positives. The system functions in the day or night and can provide high quality images. The system can communicate globally with LEO satellite communications and a 900 Mhz terrestrial radio. The system provides live action notification via web interface alerts and email notifications. Events are displayed on a map in the user interface in near real-time.

The system provides for rapid and easy deployment, has autonomous communications and power, and provides immediate install confirmation. No special skills are required to install the system and it can auto-configure.

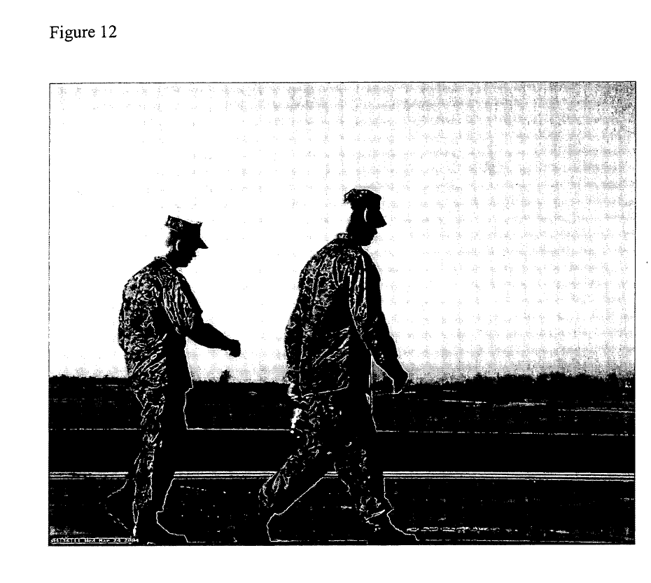

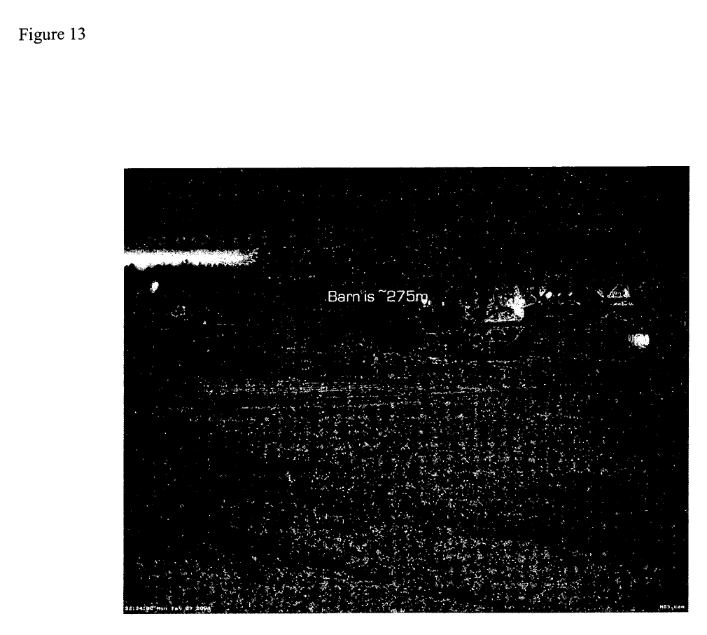

Preferably the cameras used in the system and in communication with the module operate in both daylight and during times of darkness. Preferably the daylight camera is color, has at least 2 Mega pixels resolution, uses progressive scan and has a variety of lens options. An image taken with such a camera is shown in FIG. 12. Preferably the night camera is monochrome, is capable of intensifying an image using an intensifier tube such as ITT Ultra 64LP and also has at least 2 Mega pixels resolution and is progressive scan. An image taken with such a camera is shown in FIG. 13.

A daytime and night camera can be connected to the module at the same time. The module will use the correct camera depending on lighting conditions.

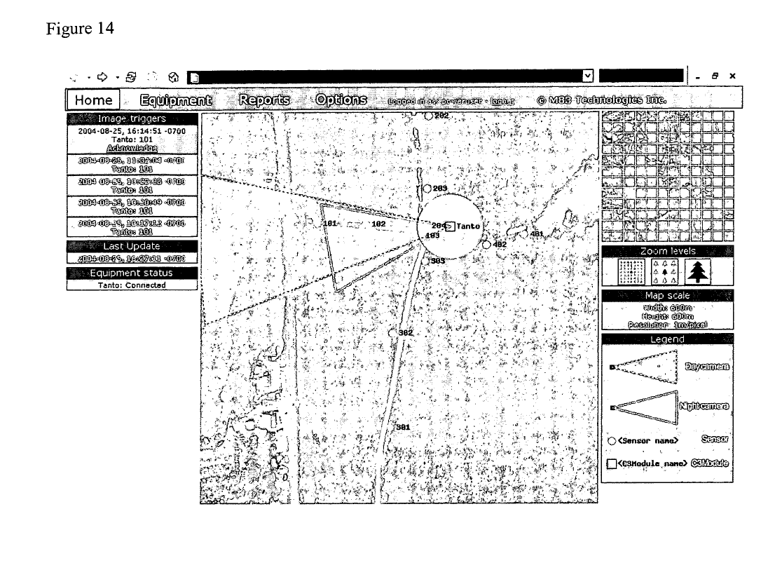

A preferred graphical user interface, as seen in FIG. 14, incorporates map based monitoring, image logs, mission planning, system configuration, and command and control for the system. Such an interface also allows for multi-user real-time management.

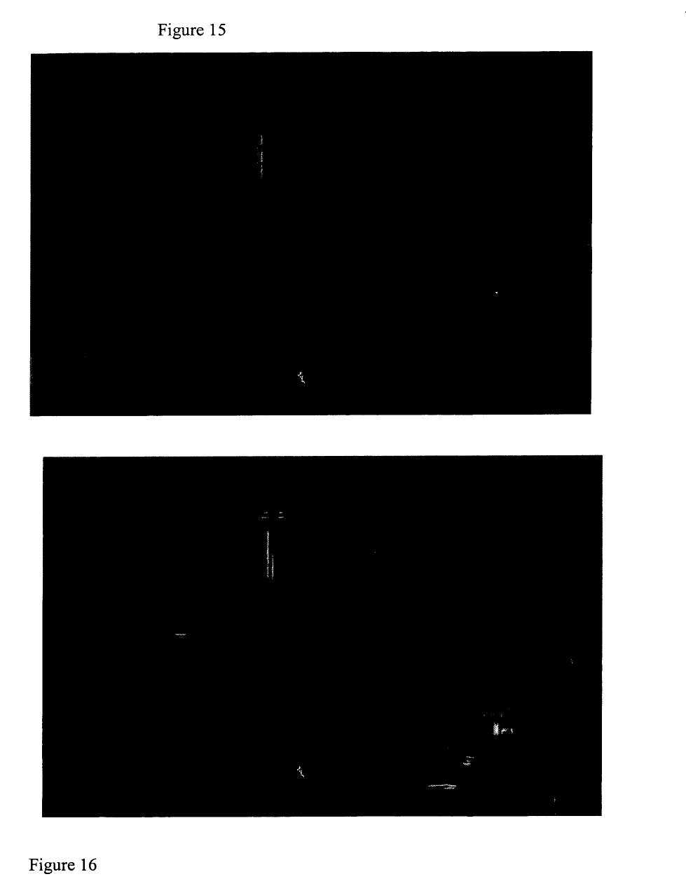

The images taken by the cameras can be transmitted by the module to a command center and/or server. FIGS. 15 through 20 provide examples of wavelet compressed images with resultant file size and transmission times using Iridium satellite at 2400 baud.

FIG. 15 shows an image file of about 500 bytes with a resultant transmission time through an iridium satellite of about 2 seconds.

FIG. 16 shows an image file of about 1 kB with a resultant transmission time through an iridium satellite of about 4 seconds.

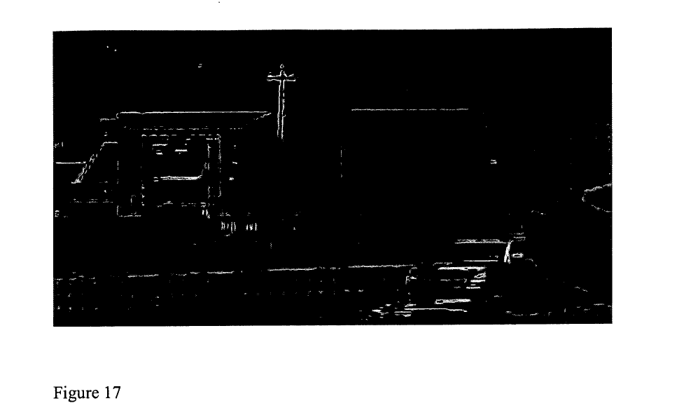

FIG. 17 shows an image file of about 2 kB with a resultant transmission time through an iridium satellite of about 8 seconds.

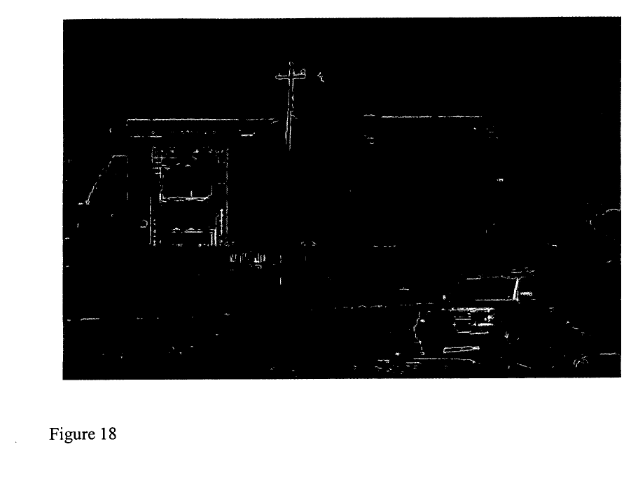

FIG. 18 shows an image file of about 5 kB with a resultant transmission time through an iridium satellite of about 20 seconds.

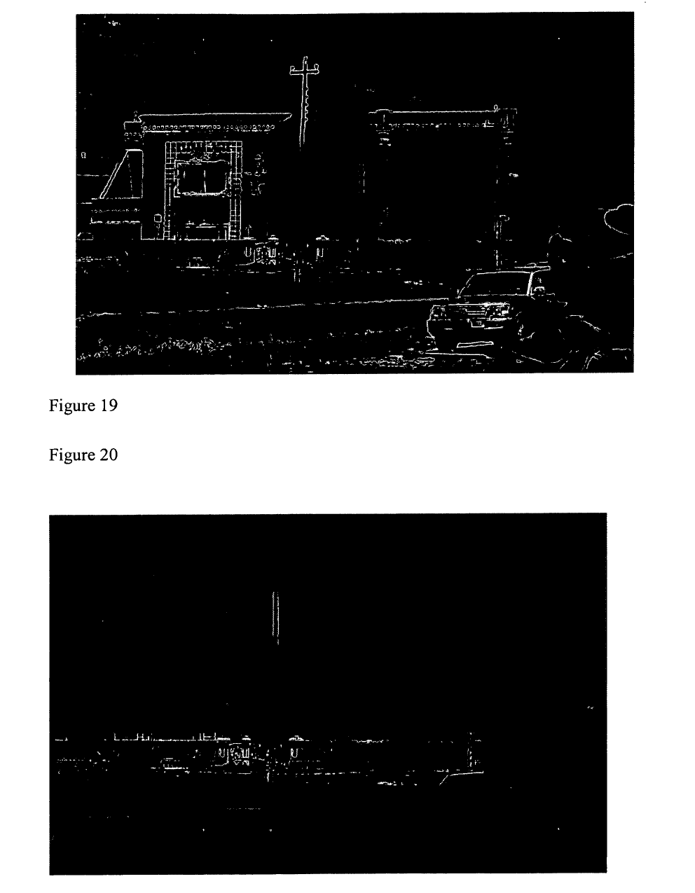

FIG. 19 shows an image file of about 25 kB with a resultant transmission time through an iridium satellite of about 1.5 minutes.

FIG. 20 shows an image file wherein a region of interest is displayed in higher quality. This image file has a file size of about 3 kB with a resultant transmission time through an iridium satellite of about 12 seconds. The region of interest is a wavelet function that can be applied to any captured image.

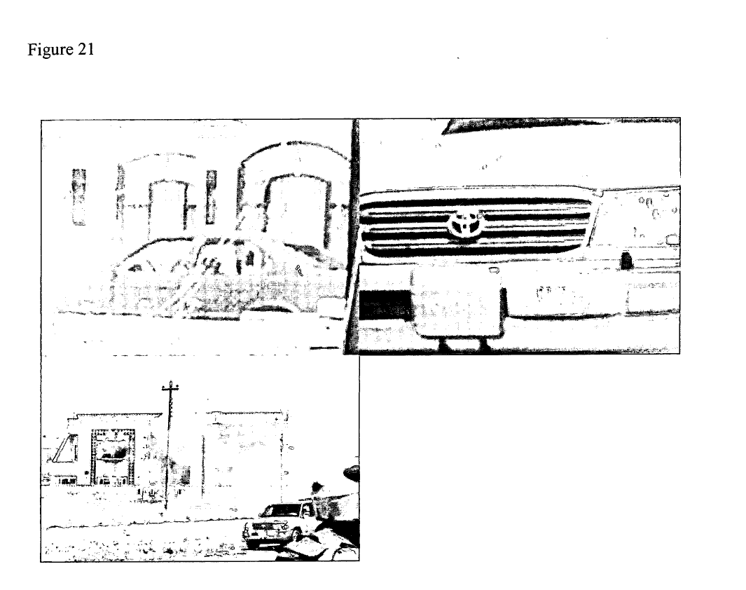

In all of the above cases, the module preferably stores a high resolution version of each image, which can later be accessed. Digital zooming can be conducted on such as images as seen in FIG. 21.

The system will employ software for several functions. Embedded software will run inside the module, and will include an operating system, sensor event discrimination algorithms, and a web user interface. Client side software will run on a personal computer or PDA for purposes such as mission planning, mission simulation, mapping interface, and receiving notification alerts. Server software will be run at the data center.

The system will employ discrimination algorithms to avoid false alarms. Real world sensor data is used to develop powerful statistical algorithms to discriminate patterns. The purpose of these algorithms is to increase the ability to determine between a positive event and a false positive event. The image confirmation will add to the reliability of the information. Multiple pattern-recognition algorithms are employed simultaneously to give the user the ability to monitor multiple scenarios.

Some of the parameters considered in these algorithms include the type of sensor activated, the time span between sensor activations and order of such activations.

The system according to the invention used auto-configuration technology based on configuration data and unique IDs that are stored in chips which are embedded in all devices and cables. When the system is installed in the field, the installer gets immediate feedback and confirmation is sent (for example to a hand held device) when new cables and devices are connected and have passed functional tests. The system is self aware and knows what types of peripherals are attached e.g. what type of camera, or battery supply is connected. During deployment the auto-configuration software detects and alerts when devices are disconnected or cables broken. The inventory is updated automatically in the field and available to all users.

The modules preferably operate for long periods of time in remote locations and therefore must conserve power. Preferably a bi-directional power bus allows each device to be provider and source of power at the same time. This can be used for instance to charge batteries from solar panels that are attached to cameras. The power management system provides redundant power paths to re-route power when a cable fails. Power status and usage patterns are monitored and reported continuously to optimize power efficiency. The power management system automatically disconnects faulty equipment to protect the other components in the system.

The power management system works in combination with smart cables. The Module communicates with and through chips in the cables. Power-control and information about the peripheral devices is automatically updated as the system is configured in the field.

Although the particular preferred embodiments of the invention have been disclosed in detail for illustrative purposes, it will be recognized that variations or modifications of the disclosed apparatus lie within the scope of the present invention.

What is claimed is:

1. A method for responding to a sensor event, comprising the steps of:
(a) recognizing and analyzing a sensor event,
(b) taking a photograph, storing the photograph, and transmitting the photograph to a central server;
(c) notifying a subscriber with a message containing said photograph and data describing the sensor event.

2. A system for gathering and transmitting information from a site, comprising:
(a) a module located at said site;
(b) a camera connected to said module;
(c) a plurality of sensors connected to said module;
(d) a plurality of digital RF connections from the module to a server; and
(e) user interface software subscribers and interrogators of the module.

3. The apparatus of claim 2, wherein the digital RF connection comprises a satellite link.

4. The apparatus of claim 2, wherein the digital RF connection comprises a wireless LAN connection.

5. The apparatus of claim 2, wherein the digital RF connection comprises a cellular connection.

6. The apparatus of claim 2, further comprising an audio signal capture device.

7. The apparatus of claim 2, wherein the sensor comprises a magnetic anomaly sensor.

8. The apparatus of claim 2, wherein the sensor comprises a seismic sensor.

9. The apparatus of claim 2, wherein the sensor comprises an infrared sensor.

10. The apparatus of claim 2, wherein the sensor comprises a trip wire.

11. The apparatus of claim 2, wherein the sensor comprises an acoustic sensor.

12. The apparatus of claim 2, wherein the camera comprises an infrared laser to allow pointing the camera at a location at night.

13. The apparatus of claim 2, wherein the camera comprises a day/night camera.

14. A methods of discriminating sensor data within a module comprising:
(a) obtain data from a plurality of sensors, said sensors capable of magnetic or seismic sensing;
(b) analyzing a time delay between the activation of seismic sensing;
(c) determining if a magnetic sensor has provided data;
(d) based on said time delay and said data provided by said magnetic sensor, establishing a threat level; and
(e) if said threat level is greater than a predetermined threshold, communicating an alert.

15. The method of claim 14 wherein said alert is communicated via a distributed network.

16. The method of claim 14, wherein said alert is communicated to a command center, and the data is selectively transmitted through a slow channel.

17. The method of claim 14 wherein the module is in communication with a camera, said camera taking a photograph when one of said sensors is communicates data, and said photograph is transmitted to a command center.
